(19) United States
(12) Patent Application Publication
(10) Pub. No.: US 2020/0273318 A1
(43) Pub. Date: Aug. 27, 2020

(54) HYGIENE COMPLIANCE PROMOTING DEVICE

(71) Applicant: Essity Hygiene and Health Aktiebolag, Goteborg (SE)

(72) Inventor: Hakan Lindstrom, Goteborg (SE)

(21) Appl. No.: 16/651,691

(22) PCT Filed: Sep. 29, 2017
(86) PCT No.: PCT/EP2017/074814

§ 371 Date: Mar. 27, 2020

(51) Int. Cl. G08B 21/24; G06Q 30/02

(52) U.S. Cl. CPC G08B 21/245; G06Q 30/0207

(57) ABSTRACT

A device is provided for promoting hygiene compliance indicating a usage of hygiene equipment by a user. The device is adapted to be carried by the user. The device includes a detection unit configured to receive signals, a memory unit, and a processing unit which is configured to process information carried by a first received signal to determine an event related to a usage of the hygiene equipment, apply a filter pre-loaded into the memory unit in response to determining the event and for letting the event pass the filter or not pass the filter, and to initiate a reward action in case the event passes the filter. The device is configured to improve promotion of use of hygiene equipment by individuals who are supposed to use this equipment.

### CROSS-REFERENCE TO RELATED APPLICATION

This application is a national phase entry of, and claims priority to, International Application No. PCT/EP2017/074814, filed Sep. 29, 2017. The above-mentioned patent application is incorporated herein by reference in its entirety.

### TECHNICAL FIELD

This application generally relates to promoting the use of hygiene equipment, such as soap, disinfectant, and/or towel dispensers, and the like. More particularly, this application relates to determining a hygiene compliance indicator or behavior by a tag that can be carried by a user, e.g., a person or individual who is supposed to use hygiene equipment at specific instances and/or according to applicable rules.

### BACKGROUND

Hygiene equipment is commonplace today in many facilities, such as hospitals, medical service centers, intensive care units, day clinics, nursing homes, private practices, lavatories, rest rooms, hotels, restaurants, cafes, food service places, schools, kindergartens, manufacturing sites, administration and office buildings, and, in general, places and facilities in which hygiene may be critical and/or that are accessible to the public or to a considerable number of individuals. The mentioned hygiene equipment thereby includes various types of individual devices and installations such as soap dispensers, dispensers for disinfectant solutions, gels or substances, towel dispensers, glove dispensers, tissue dispensers, sinks, and the like.

Although such hygiene equipment is commonplace today in many places, the use thereof by the individuals visiting these places or working in these places is still oftentimes not satisfactory. For example, hospitals, and, in general, medical service centers often suffer from hygiene deficiencies, which, in turn, may lead to the spread of infections and related diseases. In particular, such insufficient hygiene amongst medical care personnel coming into close contact with patients and bodily fluids can lead to the spread of infectious diseases amongst the personnel and other patients. It is also known that infections by highly resistant bacteria pose a severe problem in such places, especially in hospitals. In general, so-called Healthcare Associated Infections (HAI) are a real and tangible global problem in today's healthcare. HAI can be found to be currently the primary cause of death for 140,000 patients/year, affecting millions more and costs society in the range of billions of dollars/year.

At the same time, however, it is known that hygiene, and, in particular, hand hygiene, is an important factor as far as the spread of infectious diseases are concerned. Specifically, medical care personnel should make proper use of hand hygiene as often as possible so that the spread of bacteria and other disease causing substances is minimized. The actual usage of such hygiene equipment, however, may depend on—amongst others—the management of the facility, accessibility and usability of the equipment, culture, the cooperation and will exercised by the individuals working in these places or visiting such places, training of individuals, time pressure and possibly also other factors. In other words, an important factor remains the fact that individuals may not make use of installed and provided hygiene equipment although they are supposed to. Furthermore, it is generally accepted that an increased use of hygiene equipment can substantially contribute in reducing the spread of bacteria and the like, which, in turn, can drastically reduce the appearance of related infections and diseases.

For example, a corresponding relatively “low” compliance may indicate that the actual use of hygiene equipment is not satisfactory, whilst relatively “high” compliance may indicate that the actual use of hygiene equipment corresponds, within a given threshold, to some target usage, and, consequently, may be regarded as being satisfactory. A tangible figure for estimating the quality of hygiene compliance may be found in a so-called compliance metric that as such may provide many advantages, since it can give a concise picture to operators of the corresponding facility so that they may initiate measures for increasing the actual use of hygiene equipment. In general, however, there can be defined some sort of ‘target usage’ that defines how often, when and how hygiene equipment is supposed to be used.

This may in general be defined as rules, such as for example “use disinfectant dispenser whenever entering a patient room” or the like. There are already ways of measuring and/or estimating such a compliance metric in the arts, wherein the conventional approaches usually rely on measuring and/or observe “manually” by a human observer so-called opportunities and comparing these obtained opportunities to a measured/detected/observed actual use of the hygiene equipment. In other words, the opportunities reflect the above mentioned rules and indicate any event when hygiene equipment should or could have been used. By then comparing this “should/could”-value to an actual usage value a compliance metric can be calculated, as e.g. a percentage value or a ratio.

At the same time there exist technologies that not only detect the usage of hygiene equipment but also track and trace individuals so as to determine their locations and, with this, determine events of whether or not the usage of hygiene equipment would be appropriate. Such systems, however, employ more or less sophisticated technologies that collect data from the individual pieces of hygiene equipment that may be distributed over one or more premises (e.g. a hospital complex), and that determine (indoor) positions of individuals to such a degree of precision that allows for determining whether there is an opportunity to use the hygiene equipment or not. Such conventional technologies thus employ data networks, central data repositories and data processing entities, ranging and positioning equipment and the like, that all add to complexity, cost and error rate.

Thus, it would be desirable to provide improved concepts of promoting the usage of hygiene equipment that are less dependent on complex data and signal exchange, forwarding and processing. At the same time, the improved concepts should impose less of any possibly perceived privacy infringements, and a compliant behavior should be notified and rewarded as direct as possible to the individuals who are actually supposed to use the hygiene equipment and thus, ultimately should be encouraged to use this hygiene equipment.

### SUMMARY

To address these and other problems with conventional designs, a device is provided according to one embodiment for promoting hygiene compliance indicating a usage of hygiene equipment by a user. The device is adapted to be carried by the user. The device includes a detection unit configured to receive signals, a memory unit, and a processing unit which is configured to: process information carried by a first received signal to determine an event related to a usage of the hygiene equipment; apply a filter pre-loaded into the memory unit in response to determining the event and for letting the event pass the filter or not pass the filter; and to initiate a reward action in case the event passes the filter.

Further features of, and advantages with, the present invention will become apparent when studying the following detailed description. Those skilled in the art will realize that different features of the present invention may be combined to create embodiments other than those described in the following, without departing from the scope of the present invention.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, explain the one or more embodiments of the invention.

FIG. 1 is a schematic view showing a typical environment and scenario in which a user is actively using a piece of hygiene equipment according to one embodiment.

FIG. 2 is a schematic diagram illustrating a sequence of events (steps in a process) for promoting the use of hygiene equipment according to one embodiment.

FIG. 3A is a schematic view of a device that may be used in association with the piece of hygiene equipment in accordance with embodiments of the invention.

FIG. 3B is a perspective view of a mobile phone-type device that may be used in association with the piece of hygiene equipment in accordance with embodiments of the invention.

FIG. 4A is a schematic view of one filter entity according to embodiments of the invention.

FIG. 4B is a schematic view of another filter entity according to embodiments of the invention.

FIG. 5 is a flowchart of a general method enabled with the piece of hygiene equipment according to another embodiment.

### DETAILED DESCRIPTION

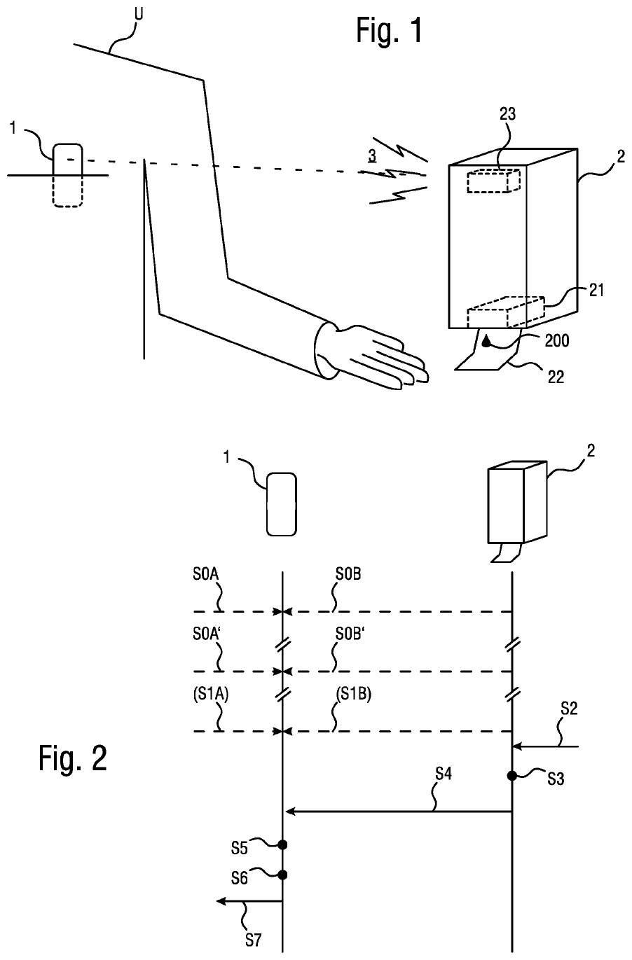

FIG. 1 shows a schematic view of a typical environment and scenario of using a piece of hygiene equipment according to an embodiment of the present invention. In general, an individual—or user U—uses a piece of hygiene equipment, here shown as an example in the form of a dispenser 2 that may be installed in a facility for dispensing soap or a disinfectant liquid. In general, however, the shown piece of hygiene equipment 2 is only an example within the present embodiment and can be well replaced by any suitable piece of hygiene equipment, including also towel dispensers, hand wash installations, sinks, and the like. Therefore, the piece of hygiene equipment as subject to the present disclosure may be generally defined as any equipment that is able to perform a hygienic action on an individual, a corresponding body part, and/or equipment or tools used and employed by such an individual. As a consequence, it is assumed in the context of the present disclosure that the use of hygiene equipment can contribute avoiding the spread of infectious or elsehow hazardous bacteria, viruses, and or substances.

The shown piece of hygiene equipment 2 includes in this embodiment a mechanism 21 to expel some amount of consumable 200 in reaction of activating a lever 22 or some other kind of detector/ actuator (e.g. a proximity sensor may activate a pump that in turn expels the amount of consumable 200). The activation and/or the expulsion of the consumable may be interpreted as a usage event, i.e. as an instance of using the piece of hygiene equipment. Upon determining such an event, the dispenser 2 may employ a signal unit 23 to emit a signal 3 that indicates the usage of the piece of hygiene equipment 2. This signal 3 is emitted into the proximity of the piece of hygiene equipment 2 so that it can be detected by a respective device 1 that is for example carried by the user U who uses the piece of hygiene equipment.

Specifically, such a device a may be provided for promoting hygiene compliance indicating the usage of hygiene equipment by the user U. The device 1 is generally adapted to be carried by the user U, implying that its size and form allows it to fit in a pocket or to be attached to a piece of clothes worn by user U. Generally, the device 1 is arranged to receive signals, such as the signal 3 emitted by the piece of hygiene equipment 2. This signal may be preferably a light signal in the visible or non-visible wavelength range, the latter including ultraviolet (UV), infrared (IR) and corresponding wavelength sub-bands. However, in general the device can be arranged to also receive other signals, including radio or sound signals. As for the former, any suitable frequencies, standards, and protocols may apply, incl. Bluetooth™, BLE, DECT, WiMAX, WLAN, NFC, UWB, and others.

Further, the device 1 includes a memory unit and a processing unit configured to process information carried by the received signal 3 to determine an event related to a usage of the piece of hygiene equipment 2, to apply a filter pre-loaded into the memory unit in response to determining the event and for letting the event pass the filter or not pass the filter, and to initiate a reward action in case the event passes the filter.

Specifically, the device 1 is configured to process information carried by the signal 3 to distinguish the signal 3 as being emitted from the piece of hygiene equipment from any other received signals that may be detectable due to identical or similar spectral characteristics. For this purpose, the signal 3 may be modulated so that information (at least with regard to a modulation frequency) can be extracted. Further, the signal 3 may even provide a variating modulation so that it carries additional information, which may indicate an identifier of the piece of hygiene equipment 2 and/or additional information relating to the usage, including for example any one of a volume of the expelled amount, a time-stamp of when the amount was expelled, information on a type of consumable (soap type, disinfectant type, etc.), and the like. In any way, the information can be employed to distinguish a received signal as being one from a piece of hygiene equipment and indicating a usage event of this piece of hygiene equipment. In this way, the device 1 can determine reliably the usage of hygiene equipment and can proceed to the next stage.

When a usage has been detected, the device 1 is configured to apply a filter that is pre-loaded into a memory unit of the device 1. Therefore, in response to determining the usage event the event can either pass the filter or not pass the filter. This filter can be implemented in various ways, including any one of a random element, a counting element, a list element, a rule element, a time chart element, and the like. The filter comprising one or more of such elements is preloaded into the device 1 so that it is available for application whenever a usage of a piece of hygiene equipment is determined. The main purpose of the filter is to select only a limited number from the full number of determined usage events, so that not every detected usage passes the filter, which would result in initiating a reward action. Rather, the preloaded filter can select only a limited number of usages that then actually result in a reward action without the necessity to consult some remote entity employing data exchange but at the same time allowing a well-defined and fair distribution of possible rewards also to a larger number of devices 1, each device carried by a different user who may use the same number of pieces of hygiene equipment.

The mentioned reward action is supposed to promote the overall use of hygiene equipment by the entirety of users having access to the hygiene equipment. In general, a number of users (e.g. personnel of a hospital including nurses, physicians, etc.) are all provided with a device 1 and have access to a number of pieces of hygiene equipment 2, including various soap/disinfectant/towel/etc. dispensers installed all over the premises. All users know of the possibility that appropriate and compliant use of the installed hygiene equipment may lead to a reward, so that the overall awareness and actual usage of the hygiene equipment is promoted and improved. The reward as such may include any one of an optical signal, acoustic signal, announcement, music, generation and/or displaying of a token or a voucher code, etc. Especially the latter voucher code can be generated and/or notified in many forms, including the display of a code on a display of the device 1, the transmission of related information to a specified email and/or messenger service, the printing of a physical voucher and the like.

In this context it should be noted that the reward action, as seen from the device, may be the mere sending of a message, since this may be sufficient to initiate the reward action, but the reward action as such is provided by other elements, including a remote computer (server). In this case, the device decides locally whether there is a reward instance or not and initiates a reward action that is ‘fulfilled’ by other elements. The device may nevertheless initiate some local notification (local message, sound and/or optical signal) to inform the user on the spot about the reward, but may leave the actual reward to other entities.

Besides the mentioned local notification, the device may send a message to another entity that then provides the reward as such. Examples include the generation and/or calling of a voucher code that is then sent to a user's email or telephone, the calling and transferring of a voice or video message, or the establishing of a voice or video call. In the former example, the user receives some value by the voucher that he or she can later claim during e.g. online shopping. In the latter two cases, for example senior staff or chief executives can personally express appreciation to the user, which may strongly contribute in promoting the use of hygiene equipment, and, with this, the compliant behavior. The mentioned message may include an ID, token or key generated or called in the device so as to authenticate the message and allowing a receiver to verify that a reward action was indeed initiated.

FIG. 2 shows a sequence of events for promoting the use of hygiene equipment according to an embodiment of the present invention. In a preparatory step S0 the device 1 receives information regarding one or more filter(s) that is/are to determine whether a determined usage event passes that filter or not. In one option S0A, a filter is received from an entity external to the device 1, e.g. a personal computer, a network server, a wireless connection access point, etc. The received information includes data that can be employed by processing resources of the device 1 so as to implement a filter in its various envisaged embodiments as they find their closer description below in conjunction with FIGS. 4A and 4B. As another or additional option S0B, the device 1 receives the data regarding a filter from a piece of hygiene equipment 2. This can be employed as an alternative S0B to the initial upload of the data, or, as an additional upload S0B′, for updating the filter data following some initial upload.

Any received data may also include data relating to rules that consider an opportunity event and/or a usage event for determining the event that is actually forwarded to the filter. In an optional step S1A/S1B data is received relating to an opportunity event. For example some beacons may emit signals, the reception of which may be indicative of an opportunity when a user is supposed to use hygiene equipment. For example, such a beacon may be installed at specific locations (e.g. close to an entrance), so that entering a specific area (e.g. ward, room, etc.) implies an opportunity for using hygiene equipment. A corresponding rule may thus be defined as “hygiene equipment is to be used whenever room . . . is entered”. As shown with alternative S1B, the opportunity related data is received directly from the piece of hygiene equipment 2. In this example, the rule may correspond to “all hygiene equipment is to be used where provided”. In such a case, however, additional time or timer information may be considered so as to avoid inappropriate assumed opportunities, when a user detects a related signal more than once although the use is contemplated only once, twice, etc.

At a stage S2, the piece of hygiene equipment 2 is used. For example, the user U employs the dispenser so as to eject an amount of disinfectant onto his/her hand(s). In response to this ‘actual use” S2, the piece of hygiene equipment 2 determines in S2 a usage event and, in response to that, executes all necessary commands and processing for emitting a signal in stage S4. This signal can be received by the device 1 being assumed to be in the vicinity of the piece of hygiene equipment 2. In step S5, information carried by the received signal is processed so as to determine an event related to the usage of hygiene equipment, i.e. the piece of hygiene equipment 2 which has transmitted the signal in step S4. In step S5, the device 1 applies the filter pre-loaded in step S0A/S0B or updated in step S0A′/S0B′ into a memory unit in response to determining the event and for letting the event pass the filter or not pass the filter. A reward action is initiated in step S7 in case the event passes the filter in step S6.

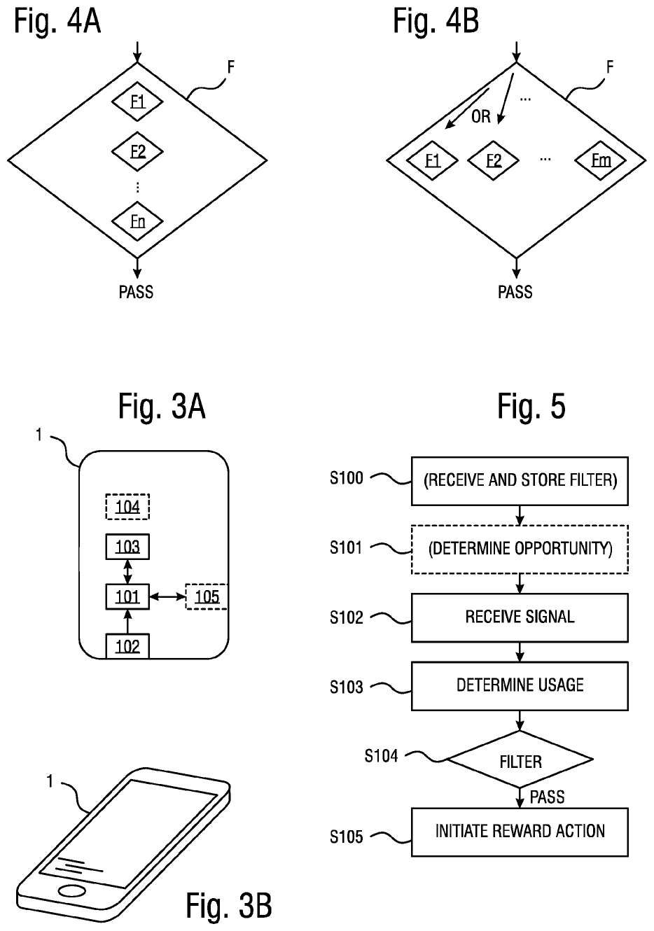

FIG. 3A shows a schematic view of a general device embodiment according to the present invention. Such a device 1 can assume any suitable form, including the form of a dedicated electronic device, a programmed but elsehow multipurpose device (e.g. smartphone, mobile phone, cordless phone, personal digital assistant, mobile computer, notebook, tablet computer, and the like). The device 1 in general is for promoting hygiene compliance indicating a usage of hygiene equipment by a user and the device is adapted to be carried by the user by its casing or additional elements, including hooks, clamps, adhesives, hook and loop fasteners, etc. The device 1 comprising a detection unit 102 configured to receive signals, a memory unit 103, and a processing unit 101. The latter is configured to, for example by executing code stored in the memory unit 103, process information carried by a first received signal to determine an event related to a usage of the hygiene equipment, apply a filter pre-loaded into the memory unit in response to determining the event and for letting the event pass the filter or not pass the filter, and to initiate a reward action in case the event passes the filter. An optional communication unit 105 may be provided to communicate data, establish and carry out a voice or video call, and/or receive an audio and/or video message. Such communication is known as such and may employ one or more of a GSM, PCS, GPRS, 3GPP, 4G, LTE, UMTS, WiMAX, WLAN, and similar standards. Further an optional display, camera and/or audio unit 104 may be provided to present any received content to a user or to conduct a voice or video call.

FIG. 3B shows a schematic view of a device embodiment according to the present invention, in which the device 1 is implemented as a multipurpose device, i.e. a smartphone, mobile phone, cordless phone, or tablet. In this alternative, the functionalities are implemented as a program (so-called ‘app’) which includes code to instruct the device's processing resources to process information carried by a first received signal to determine an event related to a usage of the hygiene equipment, apply a filter pre-loaded into the memory unit in response to determining the event and for letting the event pass the filter or not pass the filter, and to initiate a reward action in case the event passes the filter. It is notable, that the devices according to the present embodiment are generally well adapted to be carried by the user and usually include a memory unit and a processing unit. Further, a light detector (e.g. camera, infrared detector, etc.) of the device can be configured to act as a detection unit for receiving the signals.

FIG. 4A shows a schematic view of a filter entity according to an embodiment of the present invention. This filter is usually implemented as a routine or procedure being executed by the processing unit of the device and employs the data received as this has been described for example in conjunction with steps S0A/B(′) of FIG. 2. The filter F receives a determination of a usage event, which can be as simple as calling the filter F whenever a usage has been determined. Optionally, additional data can be provided to the filter F including data specifying details of the usage event (time, ID and/or type of piece of hygiene equipment and/or consumable) and/or data specifying a possible related opportunity. The filter F may further have access to additional data being pre-stored or elsehow accessible by the filter F.

In this embodiment, the individual filter elements are parsed in a consecutive manner that implies an AND-arrangement, in which an event needs to pass all the filter elements F1 . . . Fn so as to pass the filter F as a whole. In one example, one of the filter elements may be a random element and another one a time chart element with the consequence that a usage event only result in a reward if the event is randomly chosen to pass the element AND occurs at a specific time or within a specific time period. In this way, for example, a particular shift can be excluded from being rewarded, because that shift may be already considered as behaving compliant or a reward is not desired for other reasons (e.g. not distracting personnel from their work, required silence at night, or the like).

FIG. 4B shows a schematic view of another filter entity according to an embodiment of the present invention. This filter is again implemented as a routine or procedure being executed by the processing unit of the device. The filter F receives a determination of a usage event whenever a usage has been determined, and, optionally, additional data. In this embodiment, the individual filter elements are parsed in an alternative manner that implies an OR-arrangement, in which an event needs to pass at least one of filter elements F1 . . . Fm so as to pass the filter F as a whole. The filter F may further have access to additional data being pre-stored or elsehow accessible by the filter F. Naturally, there can be embodiments in which an AND-structure and an OR-structure is combined, so as to implement an arbitrary and any suitable combinations of filters F as they are described in conjunction with FIGS. 4A and 4B. For example, an even may pass the filter if a random element (e.g. F1) is passed or a time chart element (e.g. F2) is parsed but only if also counting element (e.g. F3) is passed. This could be expressed by a Boolean structure as follows:

F=(F1 OR F2) AND F3.

In general and schematic terms, the filter F may thus include one or more individual filter elements F1, F2, . . . , Fn that need to be parsed. Such elements may include any one of a random element, a counting element, a list element, a rule element, a time chart element, and the like. In sum, the filter element F determines whether or not a determined usage event result in initiating a reward action or not. For this purpose, the filter considers one or more of the following elements in order to provide a reliably, fair and appealing reward mechanism. It is to be noted that users may not be encouraged to use hygiene equipment by a system that they do not take for serious, i.e. a system that unfairly or arbitrarily rewards users. Further, the below list of exemplary filter elements is not exhaustive and embodiments of the present invention may well consider additional and appropriate filter elements.

In one embodiment, the filter F includes a random element that decides ad hoc whether or not a determined event passes on the basis of an as such known random generator, i.e. a routine that produces a result which cannot (or only in a difficult manner) be foreseen. In this way, the user can be encouraged to use the hygiene equipment by not knowing that there is a fair chance of being rewarded in response to using a piece of hygiene equipment. As an option, the random element may refer to preloaded information that distributes possible passes over a number of devices. This information may be a sequence or a time chart that varies amongst the individual device to which the information is distributed. In this way, an off-line mechanism is established that avoids unwanted accumulations of passes that occur at the same time for several devices. In other words, the chances of passes can be fairly and evenly distributed to several devices without the need for any data communication to some central entity for determining a pass or not.

In one embodiment, the filter F includes a counting element that counts a time or a number of determined usage events so as to avoid the passing of more than one event during some given time. In this way, it is avoided that reward actions are initiated in too short time intervals.

In one embodiment, the filter F includes a list element that refers to listed information for determining whether an event passes the filter element or not. For example, a time chart may be consulted in which possible times for a filter pass are listed. In this way, several time charts or lists may be generated that are then distributed to a number of individual devices. The time chart may be generated so as to avoid undesired accumulations of filter passes for more than one device. Likewise, specific times (or other factors) may be emphasized. For example, more time charts may list a specific time periods and attribute such a period with a pass of an event. In this way, specific times can be promoted, and, for example, a night shift can be explicitly rewarded more often than another shift.

In one embodiment, the filter F includes a rule element that associates usage events to usage opportunities. In this way, it can be determined whether or not a determined usage event is specifically in line with some intended compliant behavior. In this way, the users may be encouraged not only to use hygiene equipment but to use in a desired, appropriate and rule-compliant fashion. In this way, the rewarding can be emphasized for specific locations and/or situations and it is thus possible to steer a group of users toward some desired rule compliant behavior. In this way, usages can be seen in the context of specific and well defined opportunities as they may be associated to specific rules and/or recommendations. For example, the World Health Organization (WHO) has defined the so-called “Five Moments Of Hand Hygiene” (cf. www.who.int/psc/tools/Five_moments/en/) including as explicit definitions for opportunities: 1. Before patient contact; 2. Before aseptic task; 3. After body fluid exposure risk; 4. After patient contact; and 5. After contact with patient surroundings. As any one of such moments can be detected, a compliant rule element may determine whether, for example, a user has used hygiene equipment a not-too long time before a patient contact is detected.

In yet another embodiment, a super-filter is provided in the sense of considering any suitable superordinate aspect, i.e. the super-filter ensures a concerted behaviour for more than one device. In this way, any filter element can be adjusted so as provide a group-behaviour although being executed on an individual device. For example, a random element may generate a random pass but so that a desired target overall probability of more than one element in more than one device is achieved. This can be achieved, by compiling the super-filter for the group first and then splitting the super-filter into individual elements Fi that are then distributed to the individual devices. Likewise, the entire super-filter can be distributed to all devices but an individual device only evaluates a respective part of that filter.

For example, a number of filter passes may be compiled with a desired target probability of 1:5, meaning that a usage event falling in 1 out of 5 time slots will pass the filter and accordingly result in the initiation of a reward action. With the example of one time slot equalling 15 minutes, the passes can be distributed for an eight-hour shift as follows:
FF=[00100000100100000100000000100000],

where “1” indicates a possible pass and “0” no pass. Distributing this random chart from a super-filter FF to 4 devices would result in the four filter element sets F1 . . . F4:
F1=[00100000000000000000000000000000],
F2=[00000000100100000000000000000000],
F3=[00000000000000000100000000000000],
F4=[00000000000000000000000000100000].

FIG. 5 shows a flowchart of a general method embodiment of the present invention. The method is for promoting hygiene compliance indicating a usage of hygiene equipment by a user and employs a device that is adapted to be carried by a user and at least one piece of hygiene equipment which is configured to transmit a signal in response to being used. In a preparatory step S100, the device receives and stores information relating to a filter. A user carrying the device then may use a piece of hygiene equipment which confirms its use by transmitting a signal that is received by the device in step S102. In a step S103 the usage is determined by processing information carried by the received signal and an event related to a usage of the hygiene equipment is determined. In response to receiving the signal, a filter S104 is employed that is pre-loaded during step S100 for letting the determined usage event pass the filter or not pass the filter. In a step S105, a reward action is initiated in case the event passes the filter. In an optional step S101 opportunities are determined by for example also receiving, transmitting, and/or processing signals. In principle, opportunities and usages can be determined at different times and in any order, as long as one usage can be attributed to one opportunity if an according rule is to be observed and considered.

The embodiments described above are only descriptions of preferred embodiments of the present invention, and are not intended to limit the scope of the present invention. Various variations and modifications can be made to the technical solution of the present invention by those of ordinary skills in the art, without departing from the design of the present invention. The variations and modifications should all fall within the claimed scope defined by the claims of the present invention.

What is claimed is:

1. A device for promoting hygiene compliance indicating a usage of hygiene equipment by a user, said device being adapted to be carried by said user, and said device comprising:
a detection unit configured to receive signals,
a memory unit, and
a processing unit which is configured to:
process information carried by a first received signal to determine an event related to a usage of said hygiene equipment;
apply a filter pre-loaded into said memory unit in response to determining said event and for letting the event pass the filter or not pass the filter; and
initiate a reward action in case said event passes said filter.

2. The device of claim 1, wherein the processing unit is further configured to:
process information carried by a second received signal to determine an opportunity in relation to a usage of said hygiene equipment, and
determine said event based on said determined usage and opportunity.

3. The device of claim 2, wherein the processing unit is further configured to apply a hand hygiene rule pre-loaded into said memory unit when determining said event based on said determined usage and opportunity.

4. The device of claim 1, further comprising:
a notification unit adapted to convey a signal to said user in accordance with an initiated reward action.

5. The device of claim 1, further comprising:
a communication unit.

6. The device of claim 5, wherein the communication unit is adapted to transmit a message in accordance with an initiated reward action.

7. The device of claim 6, wherein the message comprises any one of a device ID, token or a key, generated or called from a preloaded location in the device so as to authenticate the message and allowing a receiver to verify that a reward action was properly initiated.

8. The device of claim 5, wherein the communication unit is adapted to receive an audio, sound, and/or video message in accordance with an initiated reward action.

9. The device of claim 5, wherein the communication unit is adapted to establish a voice or video call in accordance with an initiated reward action.

10. The device of claim 1, further comprising:
a display, camera and/or audio unit for conveying audio and/or video content to and from a user.

11. The device of claim 1, wherein the device is configured to receive and store, in said memory unit, data relating to one or more filter elements included in said filter.

12. The device of claim 11, wherein the one or more filter elements can be combined by an OR-operator and/or an AND-operator.

13. The device of claim 3, further comprising:
a notification unit adapted to convey a signal to said user in accordance with an initiated reward action; and
a communication unit,
wherein the communication unit is adapted to transmit a message in accordance with an initiated reward action,
wherein the message comprises any one of a device ID, token or a key, generated or called from a preloaded location in the device so as to authenticate the message and allowing a receiver to verify that a reward action was properly initiated,
wherein the communication unit is adapted to receive an audio, sound, and/or video message in accordance with an initiated reward action,
wherein the communication unit is adapted to establish a voice or video call in accordance with an initiated reward action,
wherein the device further comprises:
a display, camera and/or audio unit for conveying audio and/or video content to and from a user,
the device being configured to receive and store, in said memory unit, data relating to one or more filter elements included in said filter, and
wherein the one or more filter elements can be combined by an OR-operator and/or an AND-operator.
